(19) United States
(12) Patent Application Publication
(10) Pub. No.: US 2026/0335991 A1
(43) Pub. Date: Oct. 29, 2026

(54) TOOL HOLDER AND INDEXABLE CUTTING TOOL

(71) Applicant: MOLDINO Tool Engineering, Ltd., Tokyo (JP)

(72) Inventor: Fumihiko Inagaki, Narita-shi (JP)

(73) Assignee: MOLDINO Tool Engineering, Ltd., Tokyo (JP)

(21) Appl. No.: 19/111,354

(22) PCT Filed: Dec. 7, 2023
(86) PCT No.: PCT/JP2023/043838

§ 371 Date: Mar. 13, 2025

(30) Foreign Application Priority Data
Dec. 16, 2022 (JP) 2022-200838

(51) Int. Cl. B23C 5/06

(52) U.S. Cl. CPC B23C 5/06; B23C 2210/02; B23C 2210/168

(57) ABSTRACT

This tool holder includes: a pocket portion, which is provided in a tip end portion of the tool holder and is provided with a mounting seat; and a columnar portion, which is provided on a rear end side from the pocket portion. When a virtual cylindrical surface, which includes a cylindrical surface constituting a side surface of the columnar portion, is defined in the columnar portion, a first cylindrical surface, which is closest to the pocket portion, and a second cylindrical surface, which is farthest from the first cylindrical surface, are disposed on the virtual cylindrical surface. A recess, which is recessed radially inward from the virtual cylindrical surface, is disposed between the first cylindrical surface and the second cylindrical surface.

### TECHNICAL FIELD

The present invention relates to a tool holder and an indexable cutting tool.

Priority is claimed on Japanese Patent Application No. 2022-200838, filed Dec. 16, 2022, the content of which is incorporated herein by reference.

### BACKGROUND ART

An indexable cutting tool includes a cutting insert, a tool holder, and a fastening member, such as a screw, for mounting the cutting insert on the tool holder. It is known that the geometric accuracy of each member affects machined face quality and a dimensional accuracy, and in recent years there has been a trend to improve not only the geometric accuracy of the cutting insert but also the geometric accuracy of the tool holder. For example, page 2 of Non Patent Document 1 discloses that a tool having a high accuracy is provided by a tip and a tool holder which have a high accuracy, and Non Patent Document 2 discloses an effect of improving balance by increasing the accuracy of a tool holder.

### CITATION LIST

### Non Patent Document

Non Patent Document 1: Product News No. 417 Aero Chipper MAL/ALX Type, pages 2 to 3

Non Patent Document 2: Tooling by DIJET GENERAL CATALOG Vol. 10.1 2019 to 2020, pages B098 to B099

### SUMMARY OF INVENTION

### Technical Problem

Typically, a tool holder is manufactured by cutting out a desired contour shape or reference plane using a lathe or cylindrical grinding process, and then cutting out a pocket portion for fastening an insert using a machining center. To measure the shape such as the edge diameter of the tool holder, the tool holder is detached from a jig of the machining center after machining by the machining center, and the tool holder is replaced with a jig that is compatible with a measuring machine. The dimensional accuracy of the jig is controlled during manufacturing with a high fitting accuracy, but there is a slight difference in dimension between the jig used during manufacturing and the jig used during measurement. This causes the reference plane or reference axis to differ between during manufacturing and during measurement, resulting in misalignment. This misalignment affects the results of measuring a tool edge diameter or runout amount, resulting in an error between the measured dimension and the actual shape. This error is small and thus does not cause a problem in a tool holder having a normal accuracy, but this error becomes a very significant disturbance in the manufacture of a tool holder having a high accuracy.

In recent years, a shape measuring machine (a tool pre-setter) used to measure and evaluate the shape of a tool holder has had a function called an axis compensation function. This axis correction function is to detect a straight line connecting the centers of arcs of two cylindrical surfaces that are coaxially spaced apart from each other and machined with a high accuracy, as a center axis. It is known that by utilizing this axis compensation function, it is possible to eliminate disturbances caused by changing the measuring machine or the jig and detect the tool center axis of the tool holder alone. As a result, even if there is a dimensional difference between the jig used during manufacturing and the jig used during measurement, the measurement results are not affected, and the dimensional accuracy of the tool holder alone can be evaluated.

According to the inventor's investigations, it was found that when detecting the tool center axis using this axis correction function, there is a problem in that the positional relationship between the two accurately machined cylindrical surfaces affects an accuracy of the detection of the tool center axis. For example, if there is a variation in a way in which the two cylindrical surfaces are machined depending on a worker who manufactures the tool holder, the accuracy of the detection of the tool center axis may decrease. If the shape of the tool holder is measured on the basis of the tool center axis of which the detection accuracy is low, this can be a serious problem in terms of quality control, such as a tool holder completed with a good accuracy being determined to be defective or a tool holder that is outside of a tolerance being determined to be a good product, despite the fact that the measurement is performed with respect to the tool holder alone.

Furthermore, since the tool holder is provided with the two accurately machined cylindrical surfaces, there is a new created problem. When the tool holder is carried, a cylindrical outer peripheral portion of the tool holder is held. For example, in a case in which the cylindrical surface is ground to achieve an accuracy, the grinding surface is machined with a higher accuracy than the lathe-machined surface, resulting in a surface that is likely to be slippery when held in a hand. This requires a more careful operation, for example, when mounting or detaching a cutting tool with respect to a spindle of a machine tool.

In view of the above problems, one object of the present invention is to provide a tool holder that has a shape that can stably improve an accuracy of the detection of a center axis of an axis correction function using a shape measuring machine (a tool pre-setter), thereby reducing a risk of a defective product being erroneously determined to be a good product, thereby enabling stable production of a tool holder having a high accuracy, and that has a shape formed by taking an operability of a worker into consideration.

### Solution to Problem

(1) A substantially cylindrical tool holder having a tool rotation center axis, includes: a pocket portion which is provided in a tip end portion of the tool holder and is provided with a mounting seat for mounting a cutting insert; and a columnar portion which is provided on a rear end side from the pocket portion. When a virtual cylindrical surface, which includes a cylindrical surface constituting a side surface of the columnar portion and is centered on the tool rotation center axis, is defined in the columnar portion, a first cylindrical surface, which is closest to the pocket portion in a direction of the tool rotation center axis, and a second cylindrical surface, which has a diameter substantially equal to that of the first cylindrical surface and is farthest from the first cylindrical surface in the direction of the tool rotation center axis, are disposed on the virtual cylindrical surface. A recess, which is recessed radially inward from the virtual cylindrical surface, is disposed between the first cylindrical surface and the second cylindrical surface. The recess has a maximum width tmax in the direction of the tool rotation center axis of 1.0 mm or more. The first cylindrical surface and the second cylindrical surface are cylindrical grinding surfaces formed coaxially with the tool rotation center axis.
(2) In the tool holder according to (1), a maximum height roughness Rz of each of the first cylindrical surface and the second cylindrical surface may satisfy a relationship of 0.4 μm≤Rz≤6.3 μm.
(3) In the tool holder according to (1) or (2), the recess may be formed to be in a range of at least 50% or more of a circumference of the virtual cylindrical surface.
(4) In the tool holder according to any one of (1) to (3), in the direction of the tool rotation center axis, when a maximum distance of the pocket portion is L and a maximum distance between an end portion on a tip end side of the first cylindrical surface and an end portion on a rear end side of the second cylindrical surface is H, a relationship of 0.5≤H/L≤2.0 may be satisfied.
(5) In the tool holder according to any one of (1) to (4), in the direction of the tool rotation center axis, when a minimum width of the first cylindrical surface is h1 and the minimum width of the second cylindrical surface is h2, both h1 and h2 may be 0.5 mm or more and satisfy a relationship of 0.5≤h1/h2≤2.0.
(6) In the tool holder according to any one of (1) to (5), the tool holder may have a portion, which has been subjected to one or more of surface treatments such as plating, black dyeing, PVD coating, and CVD coating.
(7) In the tool holder according to any one of (1) to (6), the tool holder may have not been subjected to any surface treatment such as plating, black dyeing, PVD coating, or CVD coating.
(8) An indexable cutting tool of the present invention includes: the tool holder according to any one of (1) to (7); and a cutting insert mounted on the mounting seat.
(9) In the indexable cutting tool according to (8), each of a front runout amount and a radial runout amount may be 50 μm or less, and an edge diameter accuracy may be 90 μm or less.

### Advantageous Effects of Invention

According to one aspect of the present invention, it is possible to provide a tool holder that has a shape that can stably improve an accuracy of the detection of a center axis of an axis correction function using a shape measuring machine (a tool pre-setter), thereby reducing a risk of a defective product being erroneously determined to be a good product, thereby enabling stable production of a tool holder having a high accuracy, and that has a shape formed by taking an operability of a worker into consideration.

### BRIEF DESCRIPTION OF DRAWINGS

FIG. 1 A perspective view of a tool holder according to a first embodiment.

FIG. 2 A side view of the tool holder according to the first embodiment.

FIG. 3 A front view of the tool holder according to the first embodiment.

FIG. 4 A perspective view of an indexable cutting tool in which a cutting insert is mounted on the tool holder of the first embodiment.

FIG. 5 A perspective view of a tool holder according to a second embodiment.

FIG. 6 A side view of the tool holder according to the second embodiment.

FIG. 7 A front view of the tool holder according to the second embodiment.

FIG. 8 A perspective view of an indexable cutting tool in which a cutting insert is mounted on the tool holder of the second embodiment.

### DESCRIPTION OF EMBODIMENTS

### First Embodiment

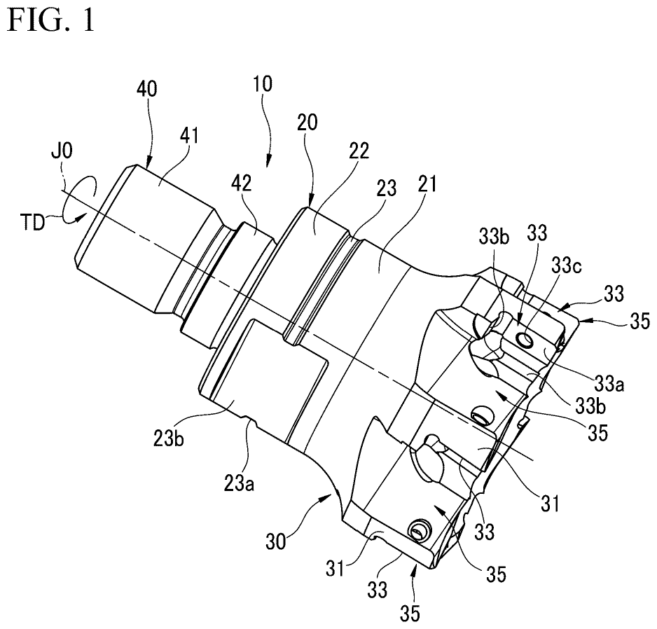

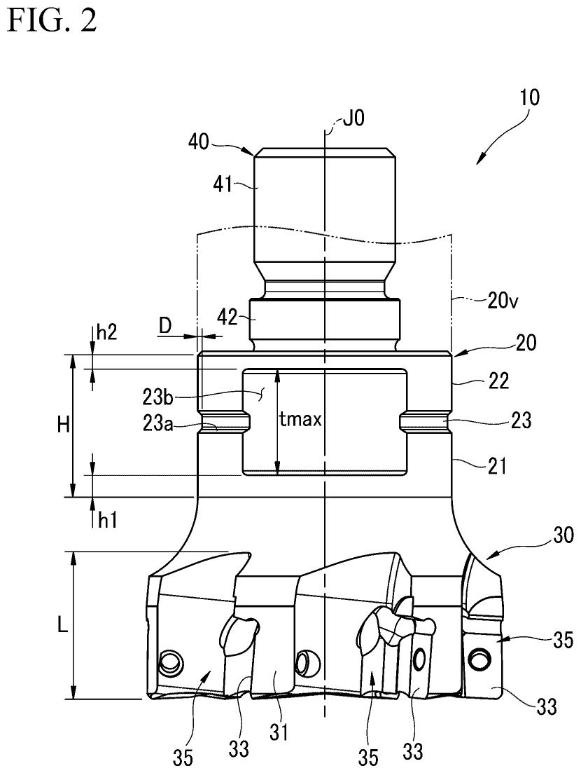

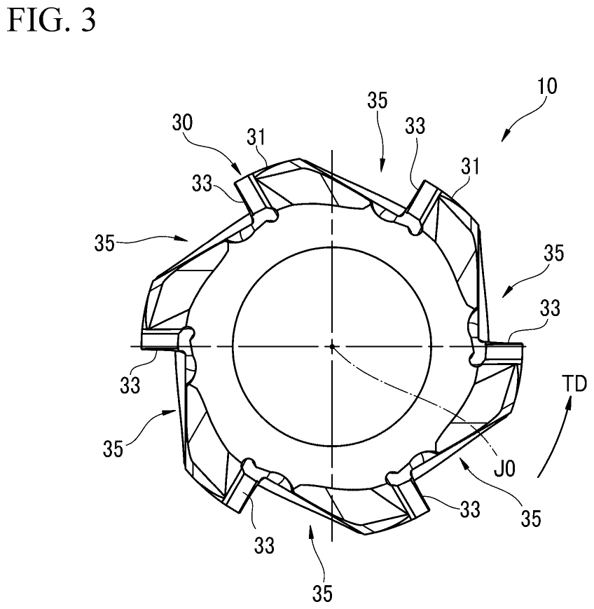

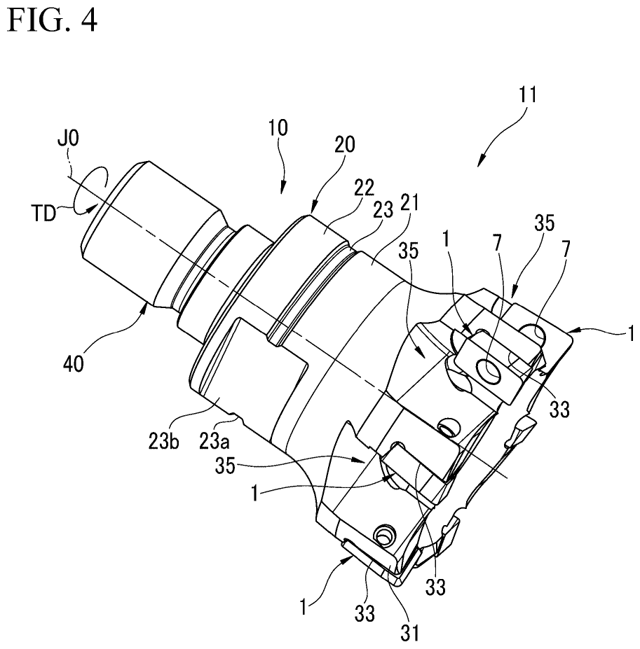

FIG. 1 is a perspective view of a tool holder according to a first embodiment. FIG. 2 is a side view of the tool holder according to the first embodiment. FIG. 3 is a front view of the tool holder according to the first embodiment. FIG. 4 is a perspective view of an indexable cutting tool in which a cutting insert is mounted on the tool holder of the first embodiment.

The tool holder of the present embodiment is a tool holder that is machined with a high accuracy, and the indexable cutting tool of the present embodiment that uses this tool holder is also a cutting tool having a high accuracy. In the indexable cutting tool of the present embodiment, for example, each of a front runout amount and a radial runout amount is 50 μm or less, and an edge diameter accuracy is 90 μm or less.

The front runout amount can be measured by mounting the same insert or test sample on each insert mounting portion and comparing dimensions in a rotation axis direction between the mounting portions with each other using a tool pre-setter or the like. The radial runout amount can be measured similarly by comparing the radial dimensions of the tool with each other. The edge diameter accuracy can be measured by mounting the same insert or test sample on each insert mounting portion and using a tool pre-setter or the like.

As shown in FIGS. 1 to 3, a tool holder 10 of the present embodiment is a substantially cylindrical tool holder having a tool rotation center axis J0. The tool holder 10 has a tip end portion 30, a columnar portion 20, and a shank connection portion 40 which are aligned along the tool rotation center axis J0.

In the following description, in an axial direction of the tool rotation center axis J0 of the tool holder 10, a direction from the shank connection portion 40 toward the tip end portion 30 is referred to as a tip end side, and a direction from the tip end portion 30 toward the shank connection portion 40 is referred to as a rear end side. A direction parallel to the tool rotation center axis J0 may be simply referred to as an axial direction. A direction perpendicular to the tool rotation center axis J0 of the tool holder 10 is called a radial direction, and a direction going around the tool rotation center axis J0 is called a circumferential direction.

The tool holder 10 has a pocket portion 35 provided with a mounting seat 33 for mounting a cutting insert 1 (see FIG. 4) on the tip end portion 30 of the tool holder 10. The columnar portion 20 extends from a rear end portion of the tip end portion 30 toward a rear end. The shank connection portion 40 extends from a rear end portion of the columnar portion 20 toward a rear end side.

The shank connection portion 40 is a portion that connects the tool holder 10 to a shank (not shown). The shank connection portion 40 extends from a rear end surface of the columnar portion 20 toward the rear end side. The shank connection portion 40 has a substantially cylindrical shape centered on the tool rotation center axis J0. The shank connection portion 40 may have a smaller diameter than the columnar portion 20. The shank connection portion 40 has a cylindrical surface 42 and a fitting portion 41 aligned in order from a side of the columnar portion 20 toward the rear end side.

The cylindrical surface 42 at the shank connection portion 40 may be indicated as the cylindrical surface 42 of the shank connection portion.

The fitting portion 41 has a male screw portion on a surface of a column centered on the tool rotation center axis J0. The fitting portion 41 fits into a fitting portion (a female screw portion) of the shank (not shown). The cylindrical surface 42 is located between the fitting portion 41 and the columnar portion 20. The cylindrical surface 42 is a cylindrical surface whose center axis is coaxial with the tool rotation center axis J0. The cylindrical surface 42 is fitted with a jig (not shown) used during manufacturing or measurement, thereby positioning the jig and the tool holder 10 relative to each other.

In the present embodiment, six mounting seats 33 and six pocket portions 35 are provided in the tip end portion 30. The number of mounting seats 33 and pocket portions 35 can be increased or decreased depending on a tool diameter, required performance, or the like of the indexable rotary cutting tool 11 shown in FIG. 4. For example, in a case in which the tool diameter is small, the number of mounting seats 33 and pocket portions 35 may be five or less, and in a case in which the tool diameter is large, the number of mounting seats 33 and pocket portions may be seven or more.

As shown in FIG. 3, the pocket portion 35 is a recess that is recessed radially inward from an outer circumferential surface 31 of the tip end portion 30. The mounting seat 33 is formed on a wall surface facing a forward side in a tool rotation direction TD of inner wall surfaces of each pocket portion 35. In the case of the present embodiment, the six mounting seats 33 are disposed at equal intervals of 60° in the circumferential direction of the tool holder 10. It may be an unequally divided configuration in which the six mounting seats 33 are disposed at unequal intervals.

The mounting seat 33 has a mounting seat bottom surface 33a and a pair of mounting seat wall surfaces 33b. The mounting seat bottom surface 33a has a rectangular shape with an area substantially equal to that of a seating surface 3 of the cutting insert 1. The mounting seat bottom surface 33a faces the tool rotation direction TD of the tool holder 10. The pair of mounting seat wall surfaces 33b are surfaces that extend from two sides of the mounting seat bottom surface 33a toward a side in the tool rotation direction TD.

The mounting seat bottom surface 33a is a surface that supports a bottom surface of the cutting insert 1. Of the pair of mounting seat wall surfaces 33b, a mounting seat wall surface 33b extending in the axial direction is a surface that supports a side surface of the cutting insert 1 along a long side thereof. Of the pair of mounting seat wall surfaces 33b, a mounting seat wall surface 33b extending in the radial direction is a surface that supports a side surface of the cutting insert 1 along a short side thereof. The pair of mounting seat wall surface 33b supports a flank face of the cutting insert 1.

A screw hole 33c is formed in approximately the center of the mounting seat bottom surface 33a. The screw hole 33c is a hole that can communicate with a mounting hole 7 formed in the center of the cutting insert 1. A mounting screw (not shown) for mounting the cutting insert 1 is inserted into the screw hole 33c. The cutting insert 1 is mounted on the tool holder 10 by tightening the mounting screw, which has inserted into the mounting hole 7 formed in the center of the cutting insert 1, into the screw hole 33c formed in the center of the mounting seat bottom surface 33a of the tool holder 10.

The tool holder 10 includes the columnar portion 20 on the rear end side from the tip end portion 30 in which the plurality of pocket portions 35 are provided. A side surface of the columnar portion 20 includes a cylindrical grinding surface centered on the tool rotation center axis J0.

Here, as shown in FIG. 2, a virtual cylindrical surface 20v including a cylindrical surface of the side surface of the columnar portion 20 is defined. At least a first cylindrical surface 21 that is closest to the pocket portion 35 in a direction of the tool rotation center axis, and a second cylindrical surface 22 that has a diameter substantially equal to that of the first cylindrical surface 21 and is farthest from the first cylindrical surface 21 in the direction of the tool rotation center axis are disposed on the virtual cylindrical surface 20v. A recess 23 that is recessed radially inward from the first cylindrical surface 21 and the second cylindrical surface 22 is disposed between the first cylindrical surface 21 and the second cylindrical surface 22.

That is, the second cylindrical surface 22 is disposed on a rear end side from the first cylindrical surface 21 with the recess 23 interposed therebetween.

The direction of the tool rotation center axis is a direction along the tool rotation center axis J0, and in FIG. 2, the direction of the tool rotation center axis indicates a vertical direction along the tool rotation center axis J0.

That is, the columnar portion 20 has a region including the cylindrical grinding surface centered on the tool rotation center axis J0 on the side surface thereof, and the cylindrical grinding surface is partitioned into the first cylindrical surface 21 and the second cylindrical surface 22 by the recess 23 in the direction of the tool rotation center axis.

In the case of the present embodiment, the recess 23 includes a groove portion 23a extending in the circumferential direction of the columnar portion 20, and a D-cut portion 23b having a rectangular shape in side view. The groove portion 23a extends in the circumferential direction within a plane perpendicular to the tool rotation center axis J0. Both ends of the groove portion 23a are connected to sides of both ends of the D-cut portion 23b in the circumferential direction, respectively. In the present embodiment, the recess 23 extends around the entire circumference of the columnar portion 20. The number of groove portions 23a can be increased depending on the size of the tool holder 10, or the like. For example, in a case in which the tool diameter of the tool holder 10 is large, two or more groove portions 23a may be provided.

The recess 23 preferably has a maximum width tmax in the direction of the tool rotation center axis of 1.0 mm or more. In the case of the present embodiment, the maximum width tmax is the maximum width of the D-cut portion 23b in the direction of the tool center axis, as shown in FIG. 2. The recess 23 may be constituted only by the groove portion 23a, and in this case, the maximum width tmax is the width of the groove 23a. By making the maximum width tmax 1.0 mm or more, the first cylindrical surface 21 and the second cylindrical surface 22 can be partitioned in a state in which the first cylindrical surface 21 and the second cylindrical surface 22 are easily visible, and the recess functions sufficiently as an anti-slip means when the tool holder 10 is handled. The upper limit value of the maximum width tmax may be 20 mm.

More preferably, a depth D of the recess 23 in the radial direction is 0.3 mm or more, and a recess having a certain depth or more in a direction other than the direction of the tool rotation center axis is provided, and thus visibility and anti-slip effect during handling are improved. In addition, the upper limit value of the depth D may be 10 mm.

The maximum width tmax and the depth D are measured using a Vernier caliper or a dimension measuring function of a microscope. Within the present embodiment, measurements of the dimensions of each member of the tool holder 10 can be performed in a similar manner.

The first cylindrical surface 21 is the cylindrical grinding surface located on the tip end side from the recess 23. In the present embodiment, a partial region of the first cylindrical surface 21 is located on the tip end side from the D-cut portion 23b. The first cylindrical surface 21 has a narrow width in the direction of the tool rotation center axis at a position axially adjacent to the D-cut portion 23b, but extends around the entire circumference of the columnar portion 20. Even in a case in which the recess 23 has a plurality of groove portions 23a, the cylindrical grinding surface located on the tip end side from the recess 23 on the most tip end side is defined as the first cylindrical surface 21. Therefore, in a case in which a plurality of groove portions 23a are provided, the cylindrical surface interposed between the groove portions 23a is not the first cylindrical surface 21.

The second cylindrical surface 22 is the cylindrical grinding surface located on the rear end side from the recess 23. In the present embodiment, a partial region of the second cylindrical surface 22 is located on the rear end side from the D-cut portion 23b. The second cylindrical surface 22 has a narrow width at a position axially adjacent to the D-cut portion 23b, but extends around the entire circumference of the columnar portion 20. Even in a case in which the recess 23 has a plurality of groove portions 23a, the cylindrical grinding surface located on the rear end side from the recess 23 on the most rear end side is defined as the second cylindrical surface 22. Therefore, in a case in which a plurality of groove portions 23a are provided, the cylindrical surface interposed between the groove portions 23a is not the second cylindrical surface 22.

It is preferable that the first cylindrical surface 21 and the second cylindrical surface 22 be manufactured by forming one cylindrical surface that is long in the axial direction of the tool holder, and then providing the recess 23 in this cylindrical surface. The first cylindrical surface 21 and the second cylindrical surface 22 have the diameters substantially equal to each other, and thus, in this case, the coaxiality is stable and the accuracy of the detection of the tool center axis can be stably improved by using an axis correction function compared to a case in which the first cylindrical surface 21 and the second cylindrical surface 22 have different diameters.

According to the tool holder 10 of the present embodiment having the above-mentioned configuration, the columnar portion 20 has the first cylindrical surface 21 and the second cylindrical surface 22 that are partitioned in the axial direction by the recess 23, and thus each of the first cylindrical surface 21 and the second cylindrical surface 22 can be used to perform the detection of the center axis by using the axis correction function of a shape measuring machine (a tool pre-setter). As a result, it is possible to eliminate disturbances caused by changing the measuring machine or the jig and evaluate the dimensional accuracy of the tool holder 10 alone. As a result of being able to perform a highly accurate measurement, it becomes possible to manufacture a tool holder 10 having a high accuracy.

In the tool holder 10 of the present embodiment, the recess 23 is disposed between the first cylindrical surface 21 and the second cylindrical surface 22, and thus an operator of the shape measuring machine (the tool pre-setter) can easily recognize the cylindrical grinding surface to be measured. If the operator of the shape measuring machine (the tool pre-setter) erroneously measures the first cylindrical surface 21 twice, the detection of the central axis is performed on the basis of the measurement results of positions that are close in the axial direction, which will reduce the accuracy of the detection of the tool center axis. If the shape measurement is performed on the basis of the tool center axis which has a low detection accuracy, a tool holder completed with a good accuracy may be determined to be defective, or a tool holder that is out a tolerance may be determined to be a good product.

With respect to this, in the present embodiment, it is possible for the operator to reliably recognize the first cylindrical surface 21 and the second cylindrical surface 22 to be measured by using the recess. By measuring the first cylindrical surface 21 and the second cylindrical surface 22 that are disposed apart from each other in the direction of the tool rotation center axis J0, the accuracy of the detection of the central axis is improved. As a result, it is possible to stabilize the accuracy determination of the tool holder 10.

In addition, when mounting or removing the tool holder 10, a user mainly grips the columnar portion 20 to perform the work. The first cylindrical surface 21 and the second cylindrical surface 22, which are cylindrically grinding surfaces, are smoothly curved surfaces and therefore are likely to be slippery when held in a hand. The columnar portion 20 is likely to be particularly slippery when cutting oil is attached thereto. With respect to this, in the tool holder 10 of the present embodiment, the recess 23 is provided, and thus the user can hook his/her finger into the recess 23 when holding the tool holder 10 in his/her hand. As a result, it is possible for the user to perform an operation of the tool holder 10 safely and smoothly.

As described above, according to the present embodiment, it is possible to provide a tool holder 10 that has a shape that can stably improve an accuracy of the detection of a center axis of an axis correction function using a shape measuring machine (a tool pre-setter), thereby reducing a risk of a defective product being erroneously determined to be a good product, thereby enabling stable production of a tool holder having a high accuracy, and that has a shape formed by taking an operability of a worker into consideration.

In the present embodiment, it is preferable that the maximum height roughness Rz of each of the first cylindrical surface 21 and the second cylindrical surface 22 satisfy a relationship of 0.4 μm≤Rz≤6.3 μm. By setting the maximum height roughness Rz within the above range, it is possible to perform the detection of the center axis by the shape measuring machine (the tool pre-setter) with a high accuracy. If the maximum height roughness Rz is less than 0.4 μm, the grinding process time for the columnar portion 20 becomes longer, the manufacturing efficiency decreases, and the manufacturing cost increases. If the maximum height roughness Rz exceeds 6.3 μm, the circumference is likely to be erroneously recognized due to the surface roughness when the axis correction function of the shape measuring machine (the tool pre-setter) is used. As a result, the accuracy of the detection of the central axis may decrease.

The maximum height roughness Rz is measured by using a surface roughness measuring machine or the like in accordance with JIS B 0601-2001.

In the present embodiment, in the direction of the tool rotation center axis J0, as shown in FIG. 2, when the maximum distance which is an axial length of the pocket portion 35 is L and the maximum distance between the end portion on the tip end side of the first cylindrical surface 21 and the end portion on the rear end side of the second cylindrical surface 22 is H, it is preferable to satisfy a relationship of 0.5≤H/L≤2.0. According to this configuration, the axial length of the columnar portion 20 relative to the entire tool holder 10 can be ensured. As a result, it is easy to ensure a large distance between the first cylindrical surface 21 and the second cylindrical surface 22 in the direction of the tool rotation center axis J0. The accuracy of the detection of the center axis is improved by using the axis correction function of the shape measuring machine (the tool pre-setter).

In the present embodiment, in the direction of the tool rotation center axis J0, when the minimum width of the first cylindrical surface 21 is h1 and the minimum width of the second cylindrical surface 22 is h2, it is preferable that both the minimum width h1 and the minimum width h2 be 0.5 mm or more and satisfy a relationship of 0.5≤h1/h2≤2.0. The upper limit of each of the minimum width h1 and the minimum width h2 may be 20 mm.

In the case of the present embodiment, the width of each of the first cylindrical surface 21 and the second cylindrical surface 22 is smallest at a position axially adjacent to the D-cut portion 23b. It is preferable that each of the minimum widths h1 and h2 at these positions be 0.5 mm or more, and the ratio of the minimum widths h1 and h2 be within the range of 0.5 to 2.0. With this configuration, a sufficient measurement region can be secured for the shape measuring machine (the tool pre-setter) on both the first cylindrical surface 21 and the second cylindrical surface 22, and the detection of the central axis can be performed efficiently and stably.

The first cylindrical surface 21 and the second cylindrical surface 22 do not need to extend around the entire circumference of the columnar portion 20 as long as the accuracy of the detection of the central axis by the shape measuring machine (the tool pre-setter) can be ensured. For example, the first cylindrical surface 21 or the second cylindrical surface 22 may be interrupted by a D-cut portion 23b. As an example, if the cylindrical grinding surface is 70% or more of the circumferential length of the columnar portion 20, it is possible to detect the central axis by using the shape measuring machine (the tool pre-setter). The required length of the cylindrical grinding surface in the circumferential direction may differ depending on the model of the shape measuring machine (the tool pre-setter).

In the present embodiment, the recess 23 extends around the entire circumference of the columnar portion 20, but the recess 23 may be interrupted in the circumferential direction of the columnar portion 20. In addition, the recess 23 may be divided into two or three or more portions in the circumferential direction. In a case in which the recesses 23 are formed only in a part of the columnar portion 20 in the circumferential direction, the total length of the recesses 23 in the circumferential direction is preferably 50% or more of the circumferential length of the virtual cylindrical surface 20v. As a result, it is possible for the user of the tool holder 10 to see at least a part of the recess 23 in any direction, and it is easy for the user to touch the recess 23 when the user holds the tool holder 10. It is possible to obtain both a function of partitioning the first cylindrical surface 21 and the second cylindrical surface 22 in the axial direction and an anti-slip function when the tool holder 10 is handled.

The tool holder 10 of the present embodiment may be a tool holder that has been subjected to a surface treatment. That is, the tool holder 10 may have a portion that has been subjected to one or more of surface treatments such as plating, black dyeing, PVD coating, and CVD coating.

In addition, the tool holder 10 of the present embodiment may be a tool holder that has not been subjected to a surface treatment. That is, the tool holder 10 may have not been subjected to any surface treatment such as plating, black dyeing, PVD coating, or CVD coating.

### Second Embodiment

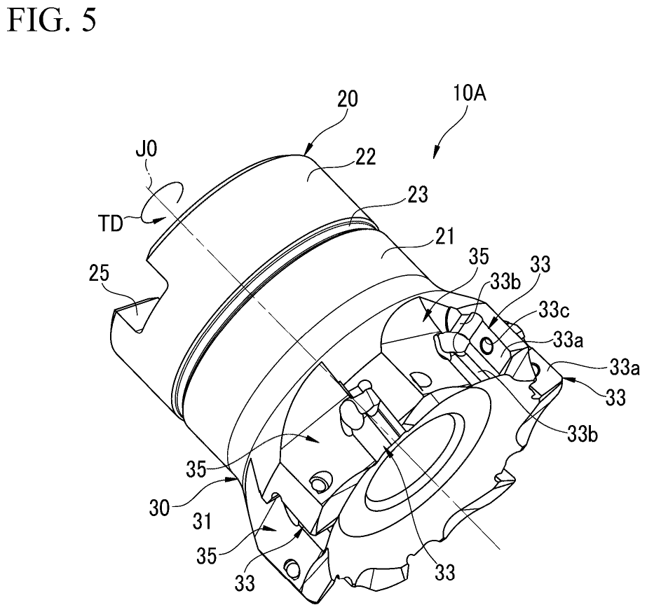

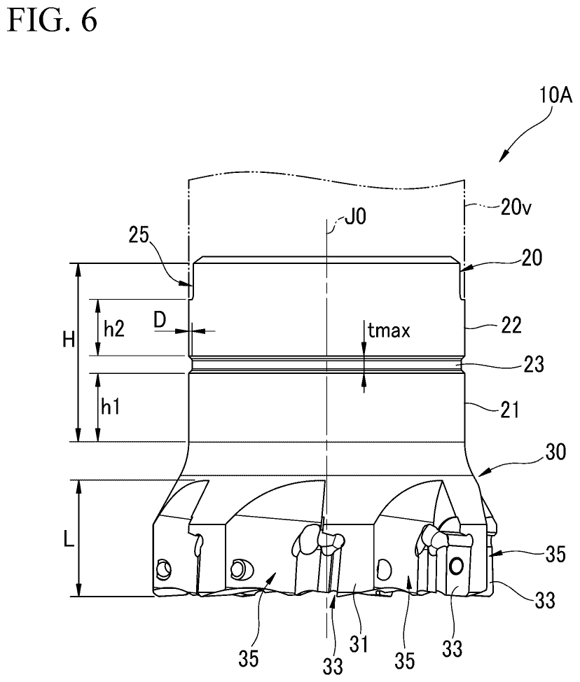

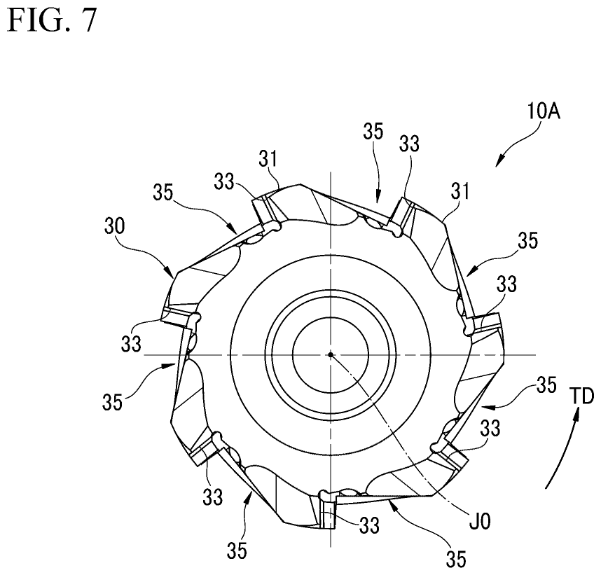

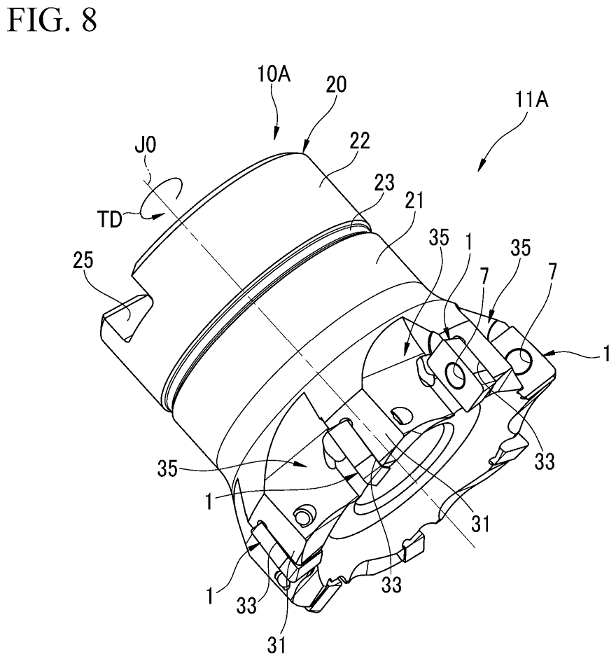

FIG. 5 is a perspective view of a tool holder according to a second embodiment.
FIG. 6 is a side view of the tool holder according to the second embodiment. FIG. 7 is a front view of the tool holder according to the second embodiment. FIG. 8 is a perspective view of an indexable cutting tool in which a cutting insert is mounted on the tool holder of the second embodiment.

The tool holder of the present embodiment is a tool holder that is machined with a high accuracy, and the indexable cutting tool of the present embodiment that uses this tool holder is also a cutting tool having a high accuracy. In the indexable cutting tool of the present embodiment, for example, each of a front runout amount and a radial runout amount is 50 μm or less, and an edge diameter accuracy is 90 μm or less.

As shown in FIGS. 5 to 7, a tool holder 10A of the present embodiment is a substantially cylindrical tool holder having a tool rotation center axis J0. The tool holder 10A has a tip end portion 30 and a columnar portion 20 which are aligned along the tool rotation center axis J0.

In the second embodiment, portions equivalent to those in the first embodiment are denoted by the same reference signs as in the first embodiment, and detailed description thereof may be omitted. In the second embodiment, in an axial direction of the tool rotation center axis J0 of the tool holder 10A, a direction from the columnar portion 20 toward the tip end portion 30 is referred to as a tip end side, and a direction from the tip end portion 30 toward the columnar portion 20 is referred to as a rear end side.

The tool holder 10A has a pocket portion 35 provided with a mounting seat 33 for mounting a cutting insert 1 (see FIG. 8) on the tip end portion 30 of the tool holder 10A. The columnar portion 20 extends from a rear end portion of the tip end portion 30 toward a rear end.

In the present embodiment, seven mounting seats 33 and seven pocket portions 35 are provided in the tip end portion 30. The number of mounting seats 33 and pocket portions 35 can be increased or decreased. The pocket portion 35 is a recess that is recessed radially inward from an outer circumferential surface 31 of the tip end portion 30. The mounting seat 33 is formed on a wall surface facing a forward side in a tool rotation direction TD of inner wall surfaces of each pocket portion 35. In the case of the present embodiment, the seven mounting seats 33 are disposed at angular intervals of 51° to 52° in the circumferential direction of the tool holder 10A.

The mounting seat 33 has a mounting seat bottom surface 33a and a pair of mounting seat wall surfaces 33b. A screw hole 33c is formed in approximately the center of the mounting seat bottom surface 33a. As shown in FIG. 8, the cutting insert 1 is mounted on the tool holder 10A by tightening a mounting screw (not shown), which has inserted into the mounting hole 7 formed in the center of the cutting insert 1, into the screw hole 33c formed in the center of the mounting seat bottom surface 33a of the tool holder 10A.

The tool holder 10A includes the columnar portion 20 on the rear end side from the tip end portion 30 in which the plurality of pocket portions 35 are provided. A side surface of the columnar portion 20 includes a cylindrical grinding surface centered on the tool rotation center axis J0. In the present embodiment, a key groove 25 is formed at the rear end portion of the columnar portion 20 and recessed from the rear end surface of the tool holder 10A toward the tip end side. The key groove 25 extends in a diametrical direction in the rear end surface of the tool holder 10A. When the tool holder 10A is mounted on a spindle of a processing machine, a key of the spindle is fitted into the key groove 25.

Here, as shown in FIG. 6, a virtual cylindrical surface 20v including a cylindrical surface of the side surface of the columnar portion 20 is defined. At least a first cylindrical surface 21 that is closest to the pocket portion 35 in a direction of the tool rotation center axis, and a second cylindrical surface 22 that has a diameter substantially equal to that of the first cylindrical surface 21 and is farthest from the first cylindrical surface 21 in the direction of the tool rotation center axis are disposed on the virtual cylindrical surface 20v. A recess 23 that is recessed radially inward from the first cylindrical surface 21 and the second cylindrical surface 22 is disposed between the first cylindrical surface 21 and the second cylindrical surface 22.

That is, the second cylindrical surface 22 is disposed on a rear end side from the first cylindrical surface 21 with the recess 23 interposed therebetween.

In the case of the present embodiment, the recess 23 consists of a groove portion extending in the circumferential direction of the columnar portion 20. The groove portion 23 consisting of the groove portion extends in the circumferential direction within a plane perpendicular to the tool rotation center axis J0. The recess 23 preferably has a maximum width tmax in the direction of the tool rotation center axis of 1.0 mm or more. In the case of the present embodiment, the maximum width tmax is a width of the groove portion. By making the maximum width tmax 1.0 mm or more, the first cylindrical surface 21 and the second cylindrical surface 22 can be partitioned in a state in which the first cylindrical surface 21 and the second cylindrical surface 22 are easily visible, and the recess functions sufficiently as an anti-slip means when the tool holder 10A is handled. The upper limit value of the maximum width tmax may be 20 mm.

More preferably, a depth D of the recess 23 in the radial direction is 0.3 mm or more, and a recess having a certain depth or more in a direction other than the direction of the tool rotation center axis is provided, and thus visibility and anti-slip effect during handling are improved. In addition, the upper limit value of the depth D may be 10 mm.

The first cylindrical surface 21 is the cylindrical grinding surface located on the tip end side from the recess 23. In the present embodiment, the first cylindrical surface 21 extends around the entire circumference of the columnar portion 20 to have a constant width.

The second cylindrical surface 22 is the cylindrical grinding surface located on the rear end side from the recess 23. In the present embodiment, the second cylindrical surface 22 has a narrow width in the direction of the tool rotation center axis at a position axially adjacent to the key groove 25, but extends around the entire circumference of the columnar portion 20.

The number of recesses 23 can be increased depending on the size of the tool holder 10A, or the like. For example, in a case in which the tool diameter of the tool holder 10A is large, two or more recesses 23 may be provided.

Even in a case in which a plurality of recesses 23 are provided, the cylindrical grinding surface located on the tip end side from the recess 23 on the most tip end side is defined as the first cylindrical surface 21. Therefore, in a case in which a plurality of recesses 23 are provided, the cylindrical surface interposed between the recesses 23 is not the first cylindrical surface 21.

Even in a case in which a plurality of recesses 23 are provided, the cylindrical grinding surface located on the rear end side from the recess 23 on the most rear end side is defined as the second cylindrical surface 22. Therefore, in a case in which a plurality of recesses 23 are provided, the cylindrical surface interposed between the recesses 23 is not the second cylindrical surface 22.

It is preferable that the first cylindrical surface 21 and the second cylindrical surface 22 be manufactured by forming one cylindrical surface that is long in the axial direction of the tool holder, and then providing the recess 23 in this cylindrical surface. The first cylindrical surface 21 and the second cylindrical surface 22 have the diameters substantially equal to each other, and thus, in this case, the coaxiality is stable and the accuracy of the detection of the tool center axis can be stably improved by using an axis correction function compared to a case in which the first cylindrical surface 21 and the second cylindrical surface 22 have different diameters.

According to the tool holder 10A of the present embodiment having the above-mentioned configuration, the columnar portion 20 has the first cylindrical surface 21 and the second cylindrical surface 22 that are partitioned in the axial direction by the recess 23, and thus each of the first cylindrical surface 21 and the second cylindrical surface 22 can be used to perform the detection of the center axis by using the axis correction function of a shape measuring machine (a tool pre-setter). As a result, it is possible to eliminate disturbances caused by changing the measuring machine or the jig and evaluate the dimensional accuracy of the tool holder 10A alone. As a result of being able to perform a highly accurate measurement, it becomes possible to manufacture a tool holder 10A having a high accuracy.

In the tool holder 10A, the recess 23 is disposed between the first cylindrical surface 21 and the second cylindrical surface 22, and thus an operator of the shape measuring machine (the tool pre-setter) can easily recognize the cylindrical grinding surface to be measured. By measuring the first cylindrical surface 21 and the second cylindrical surface 22 that are disposed apart from each other in the direction of the tool rotation center axis J0, the accuracy of the detection of the central axis is improved. As a result, it is possible to stabilize the accuracy determination of the tool holder 10A.

The first cylindrical surface 21 and the second cylindrical surface 22, which are cylindrically grinding surfaces, are smoothly curved surfaces and therefore are likely to be slippery when held in a hand. In the tool holder 10A of the present embodiment, the columnar portion 20 is provided with the recess 23, and thus the user can hook his/her finger into the recess 23 when holding the tool holder 10A in his/her hand. As a result, it is possible for the user to perform an operation of the tool holder 10A safely and smoothly.

As described above, according to the present embodiment, it is possible to provide a tool holder 10A that has a shape that can stably improve an accuracy of the detection of a center axis of an axis correction function using a shape measuring machine (a tool pre-setter), thereby reducing a risk of a defective product being erroneously determined to be a good product, and that has a shape formed by taking an operability of a worker into consideration.

In the present embodiment, it is preferable that the maximum height roughness Rz of each of the first cylindrical surface 21 and the second cylindrical surface 22 satisfy a relationship of 0.4 μm≤Rz≤6.3 μm. By setting the maximum height roughness Rz within the above range, it is possible to perform the detection of the center axis by the shape measuring machine (the tool pre-setter) with a high accuracy.

In the present embodiment, in the direction of the tool rotation center axis J0, as shown in FIG. 6, when the maximum distance which is an axial length of the pocket portion 35 is L and the maximum distance between the end portion on the tip end side of the first cylindrical surface 21 and the end portion on the rear end side of the second cylindrical surface 22 is H, it is preferable to satisfy a relationship of 0.5≤H/L≤2.0. According to this configuration, the axial length of the columnar portion 20 relative to the entire tool holder 10A can be ensured. As a result, it is easy to ensure a large distance between the first cylindrical surface 21 and the second cylindrical surface 22 in the direction of the tool rotation center axis J0. The accuracy of the detection of the center axis is improved by using the axis correction function of the shape measuring machine (the tool pre-setter).

In the present embodiment, in the direction of the tool rotation center axis J0, when the minimum width of the first cylindrical surface 21 is h1 and the minimum width of the second cylindrical surface 22 is h2, it is preferable that both the minimum width h1 and the minimum width h2 be 0.5 mm or more and satisfy a relationship of 0.5≤h1/h2≤2.0. The upper limit of each of the minimum width h1 and the minimum width h2 may be 20 mm.

In the case of the present embodiment, the width of the first cylindrical surface 21 is constant, but the width of the second cylindrical surface 22 is smallest at a position axially adjacent to the key groove 25. It is preferable that each of the minimum widths h1 and h2 at these positions be 0.5 mm or more, and the ratio of the minimum widths h1 and h2 be within the range of 0.5 to 2.0. With this configuration, a sufficient measurement region can be secured for the shape measuring machine (the tool pre-setter) on both the first cylindrical surface 21 and the second cylindrical surface 22, and the detection of the central axis can be performed efficiently and stably.

In the present embodiment as well, the first cylindrical surface 21 and the second cylindrical surface 22 do not need to extend around the entire circumference of the columnar portion 20 as long as the accuracy of the detection of the central axis by the shape measuring machine (the tool pre-setter) can be ensured.

In the present embodiment as well, the recess 23 may be interrupted in the circumferential direction of the columnar portion 20. In addition, the recess 23 may be divided into two or three or more portions in the circumferential direction. In a case in which the recesses 23 are formed only in a part of the columnar portion 20 in the circumferential direction, the total length of the recesses 23 in the circumferential direction is preferably 50% or more of the circumferential length of the virtual cylindrical surface 20v. As a result, it is possible for the user of the tool holder 10A to see at least a part of the recess 23 in any direction, and it is easy for the user to touch the recess 23 when the user holds the tool holder 10A. It is possible to obtain both a function of partitioning the first cylindrical surface 21 and the second cylindrical surface 22 in the axial direction and an anti-slip function when the tool holder 10A is handled.

The tool holder 10A of the present embodiment may be a tool holder that has been subjected to a surface treatment. That is, the tool holder 10A may have a portion that has been subjected to one or more of surface treatments such as plating, black dyeing, PVD coating, and CVD coating.

In addition, the tool holder 10A of the present embodiment may be a tool holder that has not been subjected to a surface treatment. That is, the tool holder 10A may have not been subjected to any surface treatment such as plating, black dyeing, PVD coating, or CVD coating.

### REFERENCE SIGNS LIST

1 Cutting insert
10, 10A Tool holder
20 Columnar portion
20v Virtual cylindrical surface
21 First cylindrical surface
22 Second cylindrical surface
23 Recess
30 Tip end portion
33 Mounting seat
35 Pocket portion
h1, h2 Minimum width
J0 Tool rotation center axis
Rz Roughness
tmax Maximum width

1. A cylindrical tool holder having a tool rotation center axis, comprising:
a pocket portion which is provided in a tip end portion of the tool holder and is provided with a mounting seat for mounting a cutting insert; and
a columnar portion which is provided on a rear end side from the pocket portion,
wherein, when a virtual cylindrical surface, which includes a cylindrical surface constituting a side surface of the columnar portion and is centered on the tool rotation center axis, is defined in the columnar portion,
a first cylindrical surface, which is closest to the pocket portion in a direction of the tool rotation center axis, and a second cylindrical surface, which has a diameter equal to that of the first cylindrical surface and is farthest from the first cylindrical surface in the direction of the tool rotation center axis, are disposed on the virtual cylindrical surface,
wherein a recess, which is recessed radially inward from the virtual cylindrical surface, is disposed between the first cylindrical surface and the second cylindrical surface,
wherein the recess has a maximum width tmax in the direction of the tool rotation center axis of 1.0 mm or more, and
wherein the first cylindrical surface and the second cylindrical surface are cylindrical grinding surfaces formed coaxially with the tool rotation center axis.

2. The tool holder according to claim 1,
wherein a maximum height roughness Rz of each of the first cylindrical surface and the second cylindrical surface satisfies a relationship of 0.4 μm≤Rz≤6.3 μm.

3. The tool holder according to claim 1,
wherein the recess is formed to be in a range of at least 50% or more of a circumference of the virtual cylindrical surface.

4. The tool holder according to claim 1,
wherein, in the direction of the tool rotation center axis,
when a maximum distance of the pocket portion is L and a maximum distance between an end portion on a tip end side of the first cylindrical surface and an end portion on a rear end side of the second cylindrical surface is H,
a relationship of 0.5≤H/L≤2.0 is satisfied.

5. The tool holder according to claim 1,
wherein, in the direction of the tool rotation center axis, when a minimum width of the first cylindrical surface is h1 and the minimum width of the second cylindrical surface is h2,
both h1 and h2 are 0.5 mm or more and satisfy a relationship of 0.5≤h1/h2≤2.0.

6. The tool holder according to claim 1,
wherein the tool holder has a portion, which has been subjected to one or more of surface treatments such as plating, black dyeing, PVD coating, and CVD coating.

7. The tool holder according to claim 1,
wherein the tool holder has not been subjected to any surface treatment such as plating, black dyeing, PVD coating, or CVD coating.

8. An indexable cutting tool comprising:
the tool holder according to claim 1; and
a cutting insert mounted on the mounting seat.

9. The indexable cutting tool according to claim 8,
wherein each of a front runout amount and a radial runout amount is 50 μm or less, and an edge diameter accuracy is 90 μm or less.

10. The tool holder according to claim 2,
wherein the recess is formed to be in a range of at least 50% or more of a circumference of the virtual cylindrical surface.

11. The tool holder according to claim 2,
wherein, in the direction of the tool rotation center axis,
when a maximum distance of the pocket portion is L and a maximum distance between an end portion on a tip end side of the first cylindrical surface and an end portion on a rear end side of the second cylindrical surface is H,
a relationship of 0.5≤H/L≤2.0 is satisfied.

12. The tool holder according to claim 2,
wherein, in the direction of the tool rotation center axis, when a minimum width of the first cylindrical surface is h1 and the minimum width of the second cylindrical surface is h2,
both h1 and h2 are 0.5 mm or more and satisfy a relationship of 0.5≤h1/h2≤2.0.

13. The tool holder according to claim 2,
wherein the tool holder has a portion, which has been subjected to one or more of surface treatments such as plating, black dyeing, PVD coating, and CVD coating.

14. The tool holder according to claim 2,
wherein the tool holder has not been subjected to any surface treatment such as plating, black dyeing, PVD coating, or CVD coating.
